(19) United States
(12) Patent Application Publication
(10) Pub. No.: US 2010/0139150 A1
(43) Pub. Date: Jun. 10, 2010

(54) Animal trap and station

(76) Inventor: Bruce William Thomas, Nelson (NZ)

Correspondence Address: Trent C. Keisling;KEISLING PIEPER & SCOTT PLC, Suite 340, 3739 Steele Blvd., Fayetteville, AR, 72703, US

(21) Appl. No.: 12/589,508

(22) Filed: Oct. 23, 2009

Related U.S. Application Data
(60) Provisional application No. 61/197,113, filed on Oct. 23, 2008.

(51) Int. Cl. A01M 23/24; A01M 23/00

(52) U.S. Cl. 43/81; 43/124

(57) ABSTRACT

A trap and surrounding hollow station for killing target animals. The trap includes upturned sides that prevent debris from setting off the trap. The trap includes a safety catch that permits the striker to be cocked without setting the trigger. The trap includes a downwardly moving trigger retaining a bait against the trap base with a protective shell surrounding at least part of an edible bait and resisting deformation by the trigger. The station may be a sheet of foldable material that can be formed into a hollow housing with spaced apart end and side walls. Skirts on the base can be attached to a substrate to immobilize the station.

### CROSS-REFERENCE TO RELATED APPLICATIONS

This application claims priority to and is a continuation-in-part of U.S. application Ser. No. 61/197,113, filed Oct. 23, 2008.

### STATEMENT REGARDING FEDERALLY SPONSORED RESEARCH OR DEVELOPMENT

Not Applicable.

### REFERENCE TO A MICROFICHE APPENDIX

Not Applicable.

### RESERVATION OF RIGHTS

A portion of the disclosure of this patent document contains material which is subject to intellectual property rights such as but not limited to copyright, trademark, and/or trade dress protection. The owner has no objection to the facsimile reproduction by anyone of the patent document or the patent disclosure as it appears in the Patent and Trademark Office patent files or records but otherwise reserves all rights whatsoever.

### BACKGROUND OF THE INVENTION

1. Field of the Invention

The present invention is directed to a trap for small animals and more particularly to a killing trap for small animals. Known art may be found in U.S. Class 43, subclasses 81, 67 and 85 and in other classes and subclasses.

2. Description of the Known Art

Professional trappers worldwide engaged in small mammal pest control, conservation and science research and the fur trapping industries have long been frustrated by the inadequacies of the commercial snap-traps available on the market. The snap-traps produced to date have essentially been designed and manufactured for domestic purposes and do not adequately stand up to the riggers of long-term field use. In many instances time consuming and costly pre-field preparation of traps, such as applying fish oil to steel components and preservatives to untreated wooden bases, needs to be undertaken before use and they generally require regular, time consuming servicing to remain operational in the field for a reasonable period of time.

Many of the traditional snap-traps available are poorly constructed made from inferior quality material and do not function efficiently. Inherent flaws in the basic design of snap-traps to date create problems such as non-target by-catch issues when birds/lizards etc. are caught in traps set for pests, inciting negative public reaction to worthwhile conservation programmes. Other types of traps, such as live capture cage traps and leg-hold traps, have the disadvantage of being much more bulky and/or of heavy construction. They merely restrain rather than kill the animals and unless checked regularly at short time intervals will cause captured animals unnecessary stress and suffering. As concern for animal rights grows worldwide and international animal welfare regulations become more stringent, particularly in relation to perceived indiscriminate use of toxins and inefficient traps, the number and type of traps available for serious conservation and scientific research use or large-scale pest control operations is diminishing.

Field trials of prototypes of both the traps and the protective stations that comprise the trapping system described below, confirm that the new system design has the potential to resolve most of the problems that have been a constant frustration to professional snap-trappers worldwide. By using more appropriate, durable, yet comparatively light materials for construction of the new trap design, which can easily be scaled up or down in dimension and kill capacity, this new system has the potential to produce a range of efficient, high quality, user-friendly snap-traps that can more effectively target specific groups of pests. It includes a range of lightweight but sturdy, multi-functional protective stations and trap covers for use in both terrestrial and/or arboreal situations. Trial results indicate that the stations have the potential to eliminate or significantly reduce interference and/or capture of non-target species including vulnerable birds in forest and rural environments or household pets in urban situations. Both the traps and the stations are, therefore, essential and integral components of the trapping system as a whole.

Snap traps have a long history and have been most commonly used to catch rodents in domestic situations and professionally to control rats and mice in urban and rural environments. In recent years snap-traps have been used effectively to target rodents and other small mammal pests in large scale conservation trapping programmes in natural environments in New Zealand and other parts of the world.

Despite a considerable variation in design, materials (wood, metal, plastic) and quality, snap-traps are generally of simple construction with a spring-loaded striker, a retainer mechanism to hold the loaded striker in position and a trigger to activate the loaded trap. Two main operational systems have evolved for snap-traps; one with a trigger that is invariably baited on the upper surface and activates the trap when an animal tugs at the bait and the other uses a lure to entice the target species to step onto a treadle which, through the weight of the animal, sets off the trap. Because both systems are activated by a downward pressure on the trigger or treadle they are relatively unstable devices and indiscriminate in what they catch.

U.S. Pat. No. 4,592,162 to Hallback issued on Jun. 3, 1986, is for a rodent trap with guard means that has a base with a transverse shaft secured thereto and a U-shaped jaw member that is spring loaded on the shaft. A trigger mechanism is pivotally supported on the shaft and has a catch releasably engageable with a trigger arm which holds the jaw member in spring loaded position. The trigger mechanism has a forwardly extending bait bar which holds the trigger mechanism into engagement with the spring loaded jaw member when bait is disposed under the bait bar. Guards are provided on the trigger mechanism rearwardly of the bait bar to discourage a rodent from traveling to the bait bar from the rear of the trap. This device does not provide the advantages and features of the present invention. It does not provide a bait retainer that prevents piecemeal removal of the bait nor does it provide a raised outer perimeter to prevent debris entry into the trap or accidental discharge from such materials entering the trap.

Although some modern plastic snap-traps incorporate user-friendly features and are easy to use, they are often under engineered and break when subjected to the heavy impacts required to efficiently kill a rodent or other target species, especially when used in extreme hot and/or cold environments. The age old, traditional snap-traps with wire striker that have been sold in their millions undoubtedly catch rodents, but for specialist use they are awkward to operate, not user friendly and time consuming to service during routine checks. They are inefficient, will fire spontaneously or prematurely and rodents often learn how to remove bait from them without setting the trap off. Even when they do fire they will often maim an animal rather than affect a good, clean kill. Trapping results are seldom consistent which makes them unreliable when used as a tool to gather data for scientific and conservation purposes.

The known art fails to address adequately all of the perceived problems in the field and an improved animal trap is needed, particularly one suitable for use with a protective station that restricts access to the trap to prevent untargeted animals from activating the trap.

### SUMMARY OF THE INVENTION

The present invention addresses the perceived need in the art discussed above. This new, integrated, snap-trapping system with multi-species capability is designed to catch and humanely kill pests ranging in size from mice to possums and feral cats or larger. The trap has several features not found in the known art. These include a reverse-baiting trigger, a wire coil bait, an automatic releasing safety-catch system, a raised outer perimeter protecting the trap from debris and possible unintended activation and an optional folding, multi-purpose station for housing the trap.

The present invention includes the concept of an integrated snap-trapping system, utilizing a combination of trap sizes and protective station configurations, provides flexibility in conservation science snap-trapping procedure not available prior to this development.

The present invention includes a trap and station design combined with manufacture from durable, long-lasting materials is conducive to long-term, trouble-free field use, easy replacement of parts if required and reduced timed and costs per unit during service/maintenance checks.

The present invention uses a reverse-baiting trigger combined with a coil bait that provides unprecedented snap-trap stability and reliability with much reduced incidence of trap misfire and elimination of most non-target by-catch issues.

The present invention uses a power to trap ratio that achieves consistent catch and humane kills and provides higher quality data for conservation and science purposes.

The combination of the reverse-baiting trigger and safety-catch system creates an extremely safe, user-friendly system for such powerful snap-traps.

It is an object of the present invention to provide an improved animal trap.

Another object of the present invention is to provide a trap that is safe to use but effective at killing animals humanely.

Another object of the present invention is to provide a trap that may be easily set while a safety catch prevents trap release.

Yet another object of the present invention is to provide a trap that requires an animal to forcefully remove bait therefrom to release the trap trigger.

Another object of the present invention is to provide a trap that minimizes unintended target trap triggering.

These and other objects and advantages of the present invention, along with features of novelty appurtenant thereto, will appear or become apparent by reviewing the following detailed description of the invention.

### BRIEF DESCRIPTION OF THE SEVERAL VIEWS OF THE DRAWINGS

In the following drawings, which form a part of the specification and which are to be construed in conjunction therewith, and in which like reference numerals have been employed throughout wherever possible to indicate like parts in the various views:

FIG. 1 is a side perspective view of an improved animal trap showing an exemplary embodiment in accordance with the present invention taken generally from the front thereof;

FIG. 2 is a side perspective view taken generally from the rear thereof;

FIG. 3 is a top plan view thereof;

FIG. 4 is a cross-sectional view taken along line 4-4 of FIG. 3 and with a bait inside a spiral wound wire under the trigger;

FIG. 5 is a perspective view thereof showing the trap deployed with a bait in an outer shell under the trigger;

FIG. 6 is a perspective view of another exemplary embodiment in accordance with the present invention;

FIG. 7 is a perspective view of yet another exemplary embodiment in accordance with the present invention;

FIG. 8 is a perspective view of an optional wax-block lure placed beneath the retainer to attract and monitor visitations of animals to sprung traps between captures;

FIG. 9 is a perspective view of the embodiment of FIG. 5 with an optional hood around the trigger;

FIG. 10 is a perspective view taken generally from the rear of FIG. 9;

FIG. 11 is a cross-sectional view taken along line 11-11 of FIG. 9 with the striker cocked and held by the safety catch;

FIG. 12 is a cross-sectional view similar to FIG. 11 but showing the bait captivated by the trigger and the trap in the set position awaiting activation;

FIG. 13 is a cross-sectional view similar to FIG. 12 but showing a moved position with the bait removed from beneath the trigger and with the striker beginning to deploy;

FIG. 14 is a cross-sectional view similar to FIGS. 12 and 13 but showing a moved position with the bait removed from beneath the trigger and with the striker deployed;

FIG. 15 is a side perspective view of an improved multi-functional folding station for the animal trap showing an exemplary embodiment in accordance with the present invention taken generally from the front thereof;

FIG. 16 is a side perspective view taken generally from the rear thereof;

FIG. 17 is a end elevational view thereof;

FIG. 18 is a top plan view of the folding station unfolded and flat;

FIG. 19 is a partially fragmented perspective view taken along line 20-20 of FIG. 15 with portions omitted for clarity; and,

FIG. 20 is a cross-sectional view taken along line 20-20 of FIG. 15.

### DETAILED DESCRIPTION OF THE INVENTION

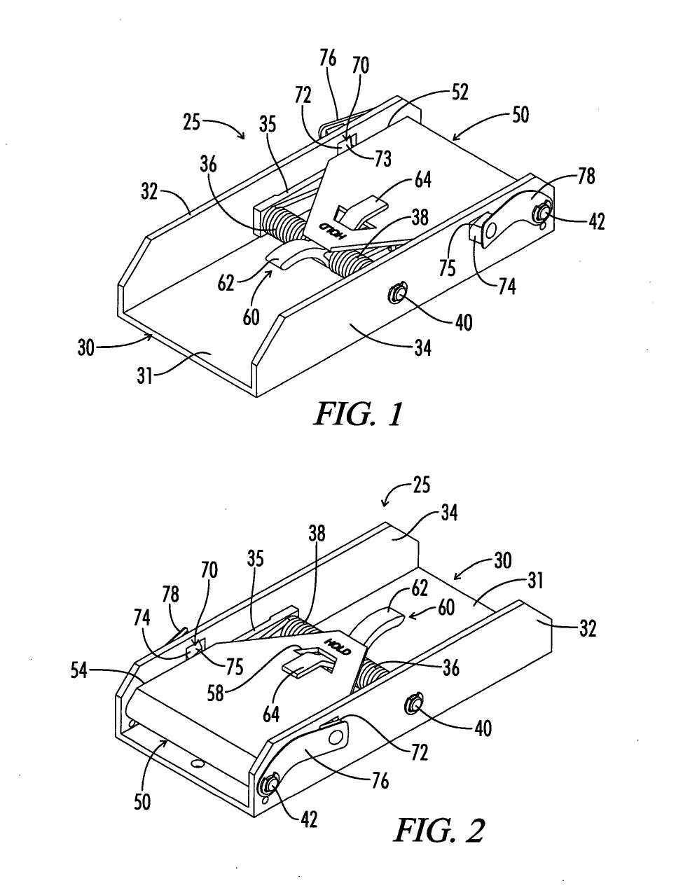

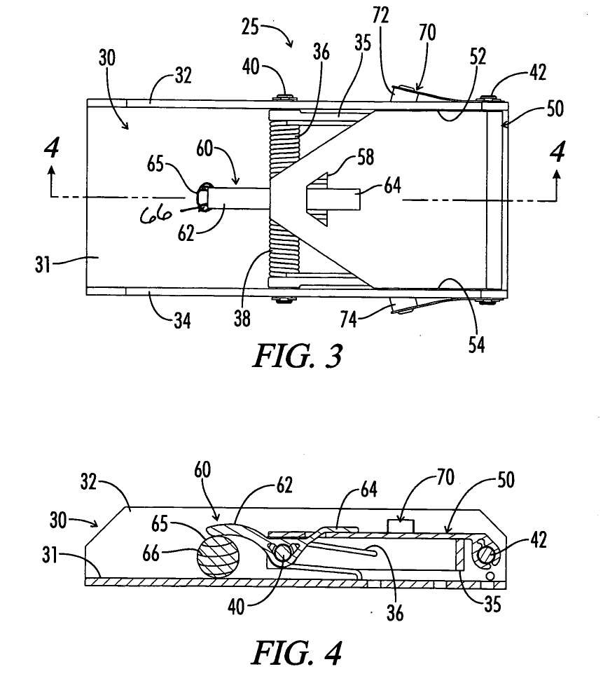

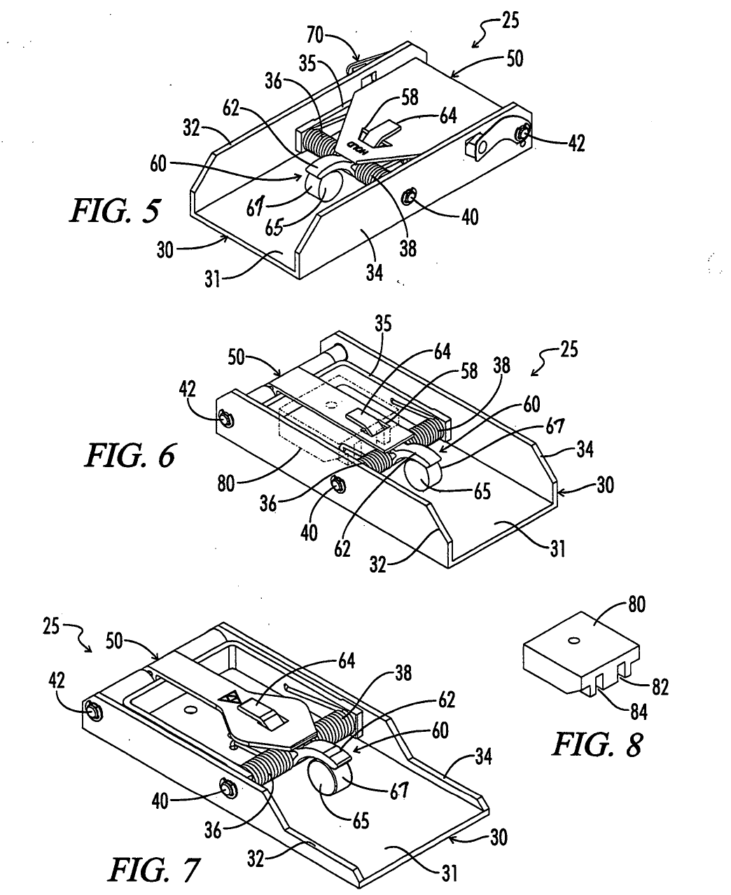

This new, integrated, snap-trapping system 24 with multi-species capability is designed to catch and humanely kill pests ranging in size from mice to possums and feral cats or larger. The novel snap-trap preferentially used in system 24 is indicated generally by reference numeral 25 in FIGS. 1-5. Trap 25 is made from durable materials, incorporates a base 30 with upturned sides 32, 34, a striker 35 (or killing bar), double torsion springs 36, 38 to power the striker 35, two shafts 40, 42 (mid and rear) to support the moving components, a retainer arm 50 to hold the loaded striker 35 in position and a unique toggle trigger 60 to activate the trap 25.

The operational design of the trigger 60 works on a reverse-baiting principle, requiring a hard bait 65 to be positioned under the trigger 60 to set the trap 25. Because the bait 65 essentially becomes a structural part of the trap 25, this new method of baiting provides much grater stability when the device is loaded than other standard snap-traps currently available. Wire coil bait retainers 66 have been specially developed to maximize this advantage.

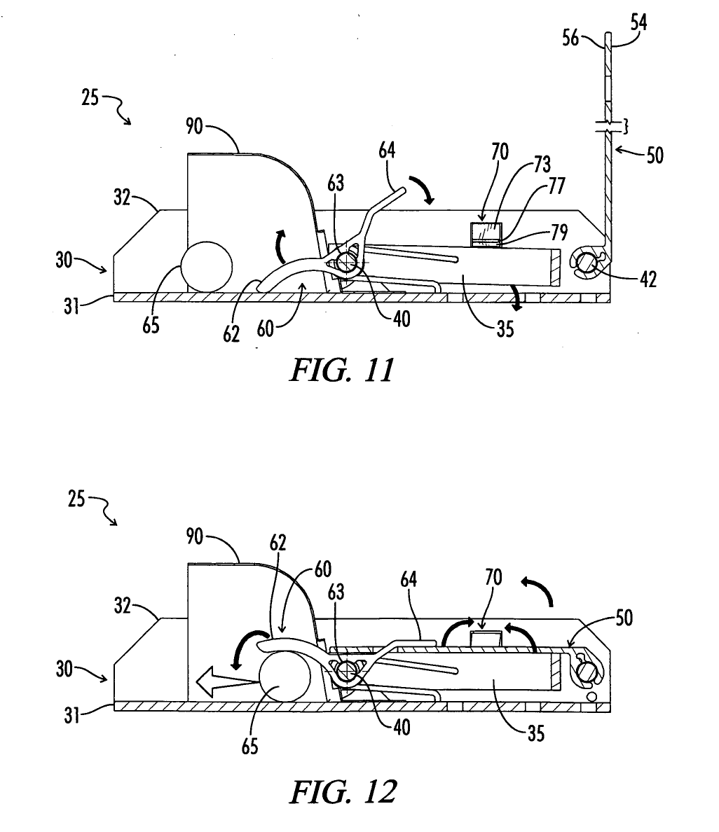

The trap design also incorporates a safety catch system 70 that secures the striker 35 when loading and automatically releases in the latter stages of the trap setting procedure—a major advance for operator safety when setting powerfully sprung snap-traps (best seen in FIG. 11).

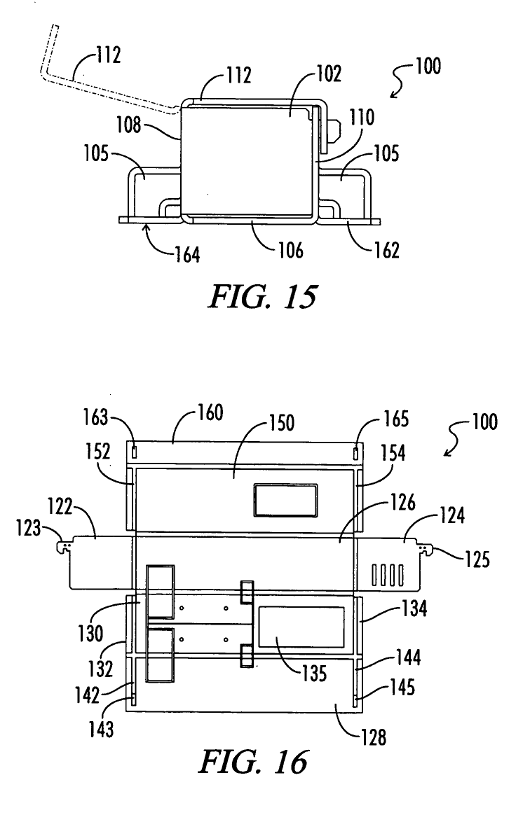

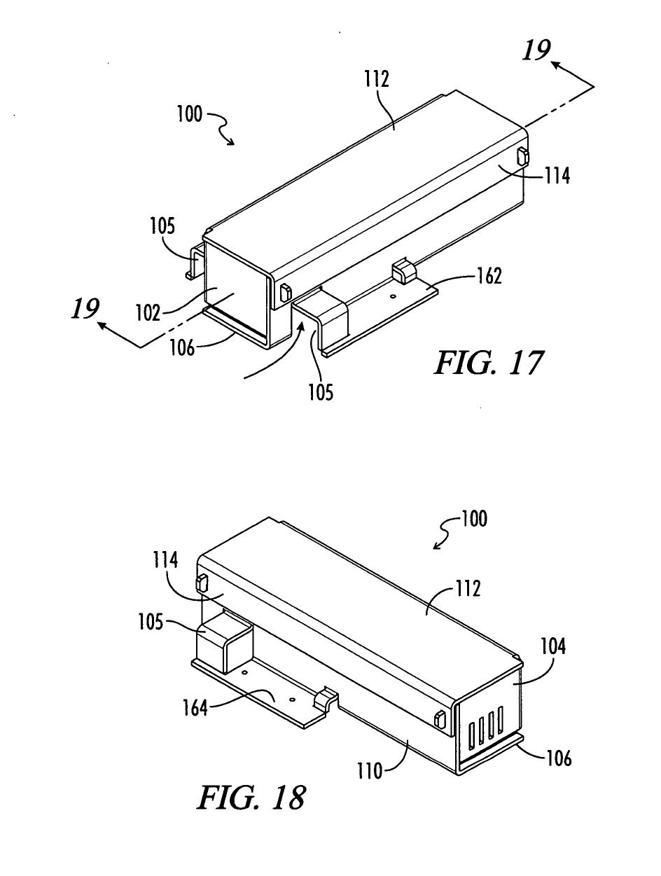

A suite of multi-purpose trap stations and/or covers of various dimension and configuration for different sized or multiple numbers of traps, bait-box inserts and/or inkpads and tracking papers will be modeled on the standard multi-functional folding-station design (FIGS. 15-20). Stations can be used in both terrestrial and/or arboreal situations and are designed to exclude or deter non-target animals such as birds and domestic pets etc., from entry or access to traps and toxins, yet provide access for the target species. Field trials confirm that station prototypes are robust, stable and effective and very easy to service.

Although an integrated, multi-species, snap-trap system is itself a novel concept overall, it also has several features not found in the known art. These include a reverse-baiting trigger 60, a wire coil bait 65, an automatic releasing safety-catch system 70 and an optional folding, multi-purpose station 100.

The reverse-baiting trigger consists of a shallow V or gull wing shaped device with one side or wing 62 longer and thicker than the other side or wing 64 and a hole through the lower central body section 63 to take the shaft 40 on which it pivots. Unlike traditional standard snap-trap triggers, which are generally spiked on top to secure the bait, this trigger 60 is entirely smooth. The trigger is positioned topside at the mid point of the shaft 40 between the two torsion springs 36, 38, with the longer thicker of the two wing elements 64 facing forwards to the front 31 of the trap 25. Extra weight causes this front wing 62 to drop to a resting position on the upper surface of the trap base 30, raising the lighter wing 64 into the air at the rear side of the shaft 40. During the setting operation, when the retainer is flipped forward, a hole in the end of the retainer arm passes over the raised rear wing 64 of the trigger 60 which, as it slides downwards, causes the front wing 62 to rise off the base 30. This enables a suitable hard bait 65 to be placed between the underside of the front wing 62 and the trap base 30 (i.e. reverse-baiting). As the loaded striker 35 pressures the retainer 50 upwards beneath the rear wing 64 of the trigger 60, it pivots the front 62 of the trigger downwards to rest firmly onto and hold the bait 65 in position. The bait 65 at this point technically becomes an added structural part of the set trap 25 and provides unequalled stability when compared to traditional top-baiting triggered snap-traps. The upper portion of the rear wing of the trigger 60, which extends beyond the hole and over the top side of the retainer 50, locks the loaded trapping mechanism in place until the bait 65 is removed and the trap 25 fires.

In one embodiment, the wire-coil bait 65 is a hollow spring-like device 66 which is filled with appropriate bait before the coil ends are folded down to encompass the bait in a protective wire casing. In another embodiment, the bait 65 uses a hard outer ring 67 into which the bait is placed. In both embodiments, since the trap 25 requires a hard bait placed beneath the trigger 60, the outer covering (i.e. the coil 66 or shell 67) provides the rigidity needed to enable use of highly palatable soft baits and also provides protection to any bait used (hard or soft) that is prone to interference from smaller non-target species.

The automatic releasing safety-catch system 70 makes setting the trap 25 easier and furnishes a safer and more user friendly trap which is particularly important with regards to the larger, more powerful units included in this suite of traps. The safety catch 70 consists of two bar catches 72, 74, seated one each side and protruding into the trap 25 through holes in the rear side walls 32, 34. The catches 72, 74 are attached by lugs to the front end of spring steel straps 76, 78 that lie flat along the outside of the trap wall and attach, either side, to the rear retainer arm shaft 42 (FIGS. 1-5). As the striker bar 35 is pulled back into loaded position it passes down the angled top surface 73, 75 of the two catches 72, 74, forcing them outwards under tension until the bar 35 has traveled completely past the catches, at which point the catches 72, 74 spring back into place but over the top of the bar 35. The striker 35 is now securely restrained by the flat underside of the catches 72, 74 in the cocked and loaded position without the need to manually hold it in place. During the next step, the two catches 72, 74 are again forced outwards when the wide retainer arm 50, which fits snugly inside the rear side walls of the trap 25 (FIG. 11), is pressed down onto the trigger 60 while simultaneously inserting trigger rear wing 64 through the retainer aperture 58. The retainer edges 52, 54 press and hold the catches 72, 74 outward and the edges 52, 54 rest against the flat catch edge 77. In this position, the striker bar 35 is released upwardly until meeting the retainer bottom 56. At this point, the striker edges are against the angled lower surface 79 of the catches 72, 74 and the striker 35 is in the firing position. While the retainer 50 is held in this position, the bait 65 is placed beneath the trigger 60 to set the trap 25. When bait 65 is firmly in place under the raised front wing 62 of the trigger 60, the trap 25 is safely set and ready to catch.

In the alternative embodiments shown in FIGS. 6 and 7, the trap 25 is without a safety catch system 70. These embodiments can be preferred when weight is a consideration, such as situations where trapping gear needs to be back-packed long distances. When setting the trap 25 in both of these alternative embodiments, the striker 35 is manually held in loaded position until leverage can be applied to the retainer 50 (narrower in these embodiments) to control the tensioned striker 35.

Referring to FIG. 6 specifically, in this alternative embodiment without safety catch 70, the trap 25 is in most other respects similar to the other embodiments and like structures are numbered similarly.

Referring to FIG. 7 specifically, in this alternative embodiment without safety catch 70, the trap 25 is in most other respects similar to the other embodiments and like structures are numbered similarly. A difference in this embodiment is that upturned sides 32 and 34 do not extend completely to the base front 31. This opens the trap adjacent its front end 31 to encourage the target animal to remove bait 65 toward the front 31 and to thus provide a more effective killing strike by striker 35 during trap activation.

FIG. 8 depicts an optional wax-block lure 80 that may be used with the trap 25. The lure 80 includes slots 82, 84 that permits installation over the bottom ends of springs 36, 38 and beneath retainer 50 and on base 30. The lure 80 is of a purpose to attract target animals to the trap 25 and becomes a particularly useful monitoring device when distinctive chew marks are left during animal visitations to sprung traps 25 between captures.

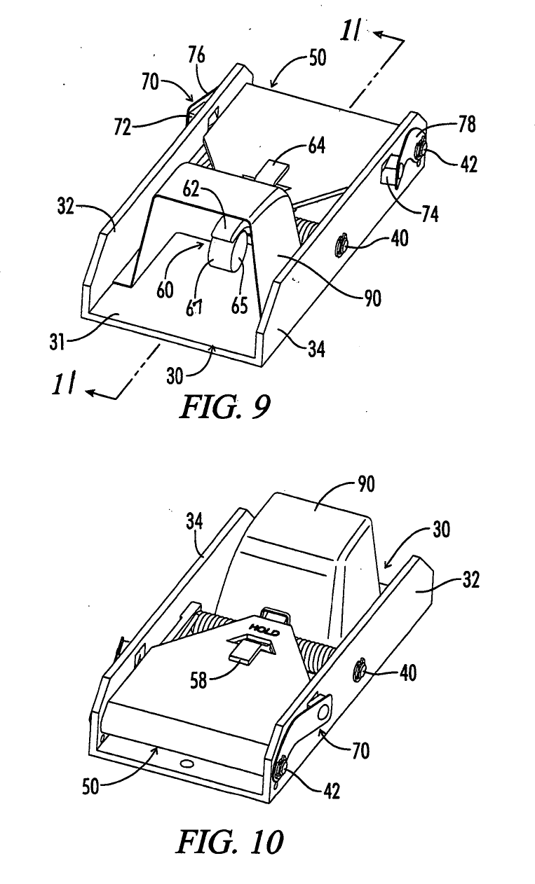

FIGS. 9 and 10 show the trap 25 used with an optional hood 90. The hood 90 fits around the bait 65 to restrict access thereto. In use, the animal is forced to the trap front 31 to access bait 65 and is thus positioned properly for a killing blow by striker 35 during activation.

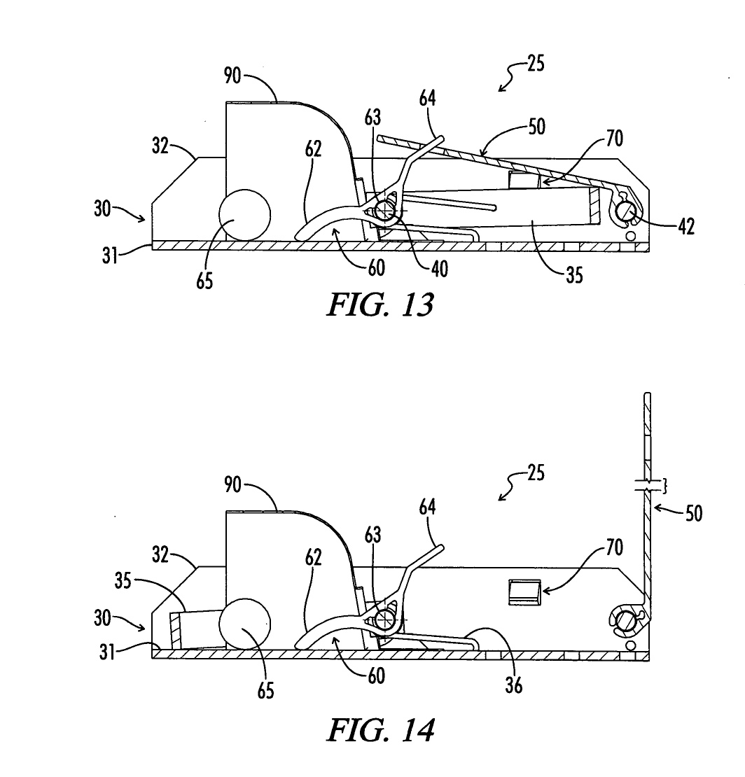

FIGS. 11-14 show the setting and activation of the trap 25. As was discussed previously, the setting of the trap involves the movement of the striker 35 beneath the catches 72, 74 and the rotation of the retainer 50 down onto the striker 35 and the insertion of the trigger wing 64 through the retainer aperture 58 and the insertion of the bait 65 beneath the trigger wing 62 (as movements are generally indicated by the arrows in FIG. 11). The activation of the trap 25 is shown in FIGS. 12-14. When the animal removes the bait 65, the trigger wing 62 is released and moves downwardly toward the base 30. The opposite end of the trigger (i.e. wing 64) moves upwardly and releases the retainer 50, which releases the striker 35. Striker 35 is biased toward the trap front 31 by springs 36, 38 and striker 35 forces retainer 50 upward and backward as the striker 35 moves upward and pivots about axle 40 to forcefully striker the animal proximate the front 31 (as the arrows generally indicate the movements in FIG. 12).

In use the trap 25 may be placed in the open or adjacent target locales, paths, food sources and the like. The trap 25 may also be advantageously deployed with station 100, shown in FIGS. 15-20.

The multi-functional protective station 100 is modeled on a flat, folding pattern which allows stations to be manufactured from a single piece of suitable light flexible material (FIGS. 15-20 and particularly FIG. 18). Alternatively, separate components made from solid sheet material can be joined by hinges to achieve the same folding advantage in a heavier version. The station 100 is a hollow shell that houses the trap 25. The station includes end walls 102, 104, a base 106, two sides 108, 110 and a pivoting top 112 that may be closed and opened via lip 114. A couple of access doors 105 permit target entry into station 100.

In the single sheet embodiment, flaps fold to form the square ended, tunnel-like station 100. The end flaps 122, 124 form the end walls. Flaps 122, 124 are folded upwardly to a vertical position on flap 126. Flap 126 with flaps 122, 124 is then rotated 90 degrees so that the edges of flaps 122 124 fit into grooves 132, 134 on base 130. Flap 128 is then rotated oppositely 90 degrees so that grooves 142, 144 abut flaps 122 and 124 and tabs 123, 125 can be inserted into holes 143, 145 to secure flap 128 thereto. The top flap 150 is then rotated over to set on end flaps 122, 124, with grooves 152, 154 receiving the top edges of flaps 122, 124. The locking lip 160 is then rotated over so that holes 163, 165 receive tabs 123, 125 to lock the lid 150.

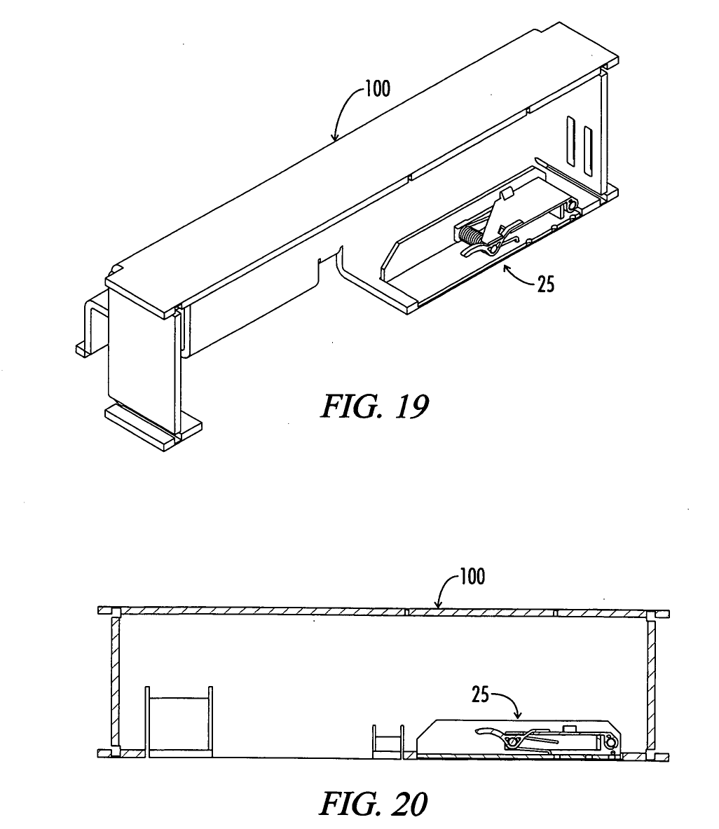

All that is required to assemble the folded station 100 is for a lug on the free, front edge of each end flap to be passed through a corresponding hole in the top outer corner at each end of the front-side wall, and is secured in place with any suitable rigid pin about the size of a match stick. The easy opening lid 150 that provides access into the station 100 is also secured by folding down over the top of the protruding lugs, adding extra support to an already sturdy unit. The trap 25 is constrained by seated into a recess 135 provided in the fully attached base or section of floor at one end of the station (FIGS. 19 and 20), preventing forward movement of the trap 25 when bait is pulled from beneath the firm grip of the trigger.

The other half of the base or floor is split down the centre to provide two flaps that fold outwards to form skirts 162, 164 that can be weighted or pinned to secure the station 100 securely to the substrate, be the station positioned in a building, on uneven ground or placed in a tree. Two different sized covered, entranceways 105 are created on each side in pop-up style by partial cuts across each end of the skirts 162, 164 and part way up the bottom of the side walls (FIGS. 15 and 17-20). These entrances 105 provide unrestricted access to the target pest species being strategically located and of a size that will prevent or massively reduce interference to traps or toxins by persistent, non-targets such as birds and household pets. Extra baffles and/or other simple accessories can be introduced to resolve specific non-target issues where problems occur (e.g. land crabs on coral atolls in the Pacific). In use, the station 100 houses the trap 25 to prevent non-target animals from accessing the trap 25 and to prevent unwanted kills.

In describing a preferred embodiment of the invention illustrated in the drawings, specific terminology has been used for the sake of clarity. However, the invention is not intended to be limited to the specific terms selected, and it is to be understood that each specific term includes all technical equivalents which operate in a similar manner to accomplish a similar purpose.

What is claimed is:

1. A trap for killing a target animal removing bait from the trap, the trap comprising:
an elongated rigid base with spaced apart ends and spaced apart upturned side walls;
an axle spanning between the side walls;
a trigger mounted on the axle and adapted to captivate bait between the trigger and the base;
a retainer pivotally mounted between the side walls proximate a first end of the base;
a striker pivotally mounted on the axle;
a spring biasing the striker opposite the first end; and,
whereby the trigger can be set to captivate the bait and temporarily secure the retainer over the striker in a biased position proximate the first end until the target animal removes the bait and releases the trigger which then pivots to release the striker to forcefully strike the target animal proximate the base end opposite the first end.

2. The trap as recited in claim 1 further comprising a safety catch on each of the side walls that can temporarily secure the striker proximate the base while securing the bait beneath the trigger.

3. The trap as recited in claim 1 further comprising a hollow station surrounding the trap, the station comprising spaced apart end and side walls supported by a base and with a hinged top and with at least one opening penetrating a side wall to permit the animal to enter the station.

4. The trap as recited in claim 3 where the station is formed from a single sheet.

5. The trap as recited in claim 4 where the station further comprises a recess in the base adapted to receive the trap.

6. The trap as recited in claim 1 wherein the bait further comprises a rigid shell at least partially surrounding a softer edible material and adapted to resist deformation by downward trigger pressure.

7. The trap as recited in claim 1 wherein the bait further comprises a spiral winding about a softer edible material and adapted to resist deformation by downward trigger pressure.

8. A hollow station adapted to be placed on a supporting substrate to house a set trap for killing an animal entering the station and activating the trap, the station comprising spaced apart end and side walls supported by a base and with a hinged top and with at least one opening penetrating a side wall to permit the animal to enter the station to activate the trap.

9. The station as recited in claim 8 where the station further comprises a recess in the base adapted to receive the trap.

10. The station as recited in claim 9 where the recessed trap seat provides constraint preventing forward movement of the trap when bait is removed from the tight grip of the trigger.

11. The station as recited in claim 8 where the station is formed from a single sheet of material adapted to be folded into a usable configuration.

12. The station as recited in claim 8 wherein the station further comprises at least one skirt that may be secured to the substrate to immobilize the station.

13. A system for killing animals comprising:
a trap activated by the animal removing bait from the trap, the trap comprising an elongated rigid base with spaced apart ends and spaced apart upturned side walls, an axle spanning between the side walls, a trigger mounted on the axle and adapted to captivate bait between the trigger and the base, a retainer pivotally mounted between the side walls proximate a first end of the base, a striker pivotally mounted on the axle, a spring biasing the striker opposite the first end, whereby the trigger can be set to captivate the bait and temporarily secure the retainer over the striker in a biased position proximate the first end until the target animal removes the bait and releases the trigger which then pivots to release the striker to forcefully strike the target animal proximate the base end opposite the first end; and,
a hollow station surrounding the trap, the station comprising spaced apart end and side walls supported by a base and with a hinged top and with at least one opening penetrating a side wall to permit the animal to enter the station to activate the trap.

14. The system as recited in claim 13 further comprising a safety catch on each of the side walls that can temporarily secure the striker proximate the base while securing the bait beneath the trigger.

15. The system as recited in claim 13 where the station is formed from a single sheet of material adapted to be folded into a usable configuration the station is formed from a single sheet.

16. The system as recited in claim 13 where the station further comprises a recess in the base adapted to receive the trap.

17. The system as recited in claim 16 where the recess provides stable seating for the trap preventing trap movement as the bait is removed and when the trap fires.

18. The system as recited in claim 13 wherein the bait further comprises a rigid shell at least partially surrounding a softer edible material and adapted to resist deformation by downward trigger pressure.

19. The system as recited in claim 13 wherein the bait further comprises a spiral winding about a softer edible material and adapted to resist deformation by downward trigger pressure.

20. The system as recited in claim 13 wherein the station further comprises at least one skirt that may be secured to the substrate to immobilize the station.
